(19) United States
(12) Patent Application Publication
(10) Pub. No.: US 2008/0309600 A1
(43) Pub. Date: Dec. 18, 2008

(54) DISPLAY APPARATUS AND METHOD FOR DRIVING THE SAME

(75) Inventors: Jun-Woo LEE, Anyang-si (KR); Hee-Seop KIM, Hwaseong-si (KR); Hyeok-Jin LEE, Seongnam-si (KR); Ji-Won SOHN, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/013,134

(22) Filed: Jan. 11, 2008

(30) Foreign Application Priority Data
Jun. 13, 2007 (KR) 10-2007-0057922

(51) Int. Cl. G09G 3/36

(52) U.S. Cl. 345/89

(57) ABSTRACT

A display apparatus includes pixels, a signal controller, a gray-scale voltage generator, and a data driver. The signal controller converts input image signals having a first frame frequency to first and second output image signals having a second frame frequency. The second output image signal is an interpolation between the input image signal for the present frame and an input image signal for a next frame after the present frame. The gray-scale voltage generator outputs a first gray-scale voltage group and a second gray-scale voltage group. The data driver converts the first output image signal to a first data voltage based on the first gray-scale voltage group and converts the second output image signal to a second data voltage based on the second gray-scale voltage group, and outputs the first and second data voltages to the pixels in a present frame.

### CROSS-REFERENCE TO RELATED APPLICATION

This application claims priority from and the benefit of Korean Patent Application No. 10-2007-0057922, filed on Jun. 13, 2007, which is hereby incorporated by reference for all purposes as if fully set forth herein.

### BACKGROUND OF THE INVENTION

1. Field of the Invention

The present invention relates to a display apparatus and a method for driving the display apparatus, and more particularly, to a display apparatus capable of improving a display quality thereof and a method for driving the display apparatus.

2. Discussion of the Background

A liquid crystal display (LCD) is a flat panel display that includes a lower substrate on which a pixel electrode is arranged, an upper substrate on which a common electrode is arranged, and a liquid crystal layer interposed between the lower substrate and the upper substrate. When a voltage difference is applied between the pixel electrode and the common electrode, an electric field is generated across the liquid crystal layer. The alignment of liquid crystal molecules in the liquid crystal layer depends upon the generated electric field and adjusts the transmittance of incident light passing through the liquid crystal molecules to display a desired image.

A vertical alignment mode LCD, in which long axes of the liquid crystal molecules are vertically aligned with respect to the lower substrate and the upper substrate without the electric field, may have an improved contrast ratio and a wider viewing angle.

In order to realize the wide viewing angle of the vertical alignment mode LCD, an LCD having openings or protrusions in the pixel electrode, the common electrode, or both may allow the liquid crystal molecules to be aligned in various directions.

However, the vertical alignment mode LCD may have a lower side visibility. For instance, in a patterned vertical alignment (PVA) mode LCD, an image may be brighter closer to the edges so that the image deteriorates due to the brightness in a high gray-scale.

For the side visibility, a driving method that divides one pixel into two sub-pixels, each having a switching device and separate voltages, has been suggested.

However, although different voltages are applied to two sub-pixels, a driving circuit for one pixel may be complicated if two switching devices are used to drive one pixel.

### SUMMARY OF THE INVENTION

This invention provides a display apparatus having a simplified circuit configuration and an improved display quality.

The present invention also provides a method for driving the display apparatus.

Additional features of the invention will be set forth in the description which follows, and in part will be apparent from the description, or may be learned by practice of the invention.

The present invention discloses a display apparatus includes a pixel, a signal controller, a gray-scale voltage generator, and a data driver. The a signal controller is to receive an input image signal of a present frame and an input image signal of a next frame, to compensate the input image signal of the present frame to output a first output image signal during a first period of the present frame, and to interpolate the input image signal of the present frame and the input image signal of the next frame to output a second output image signal during a second period of the present frame, the second period having a duration that is different than a duration of the first period. The gray-scale voltage generator is to generate a first gray-scale voltage group corresponding to a first gamma curve and a second gray-scale voltage group corresponding to a second gamma curve. The data driver is to convert the first output image signal to a first data voltage based on the first gray-scale voltage group, to convert the second output image signal to a second data voltage based on the second gray-scale voltage group, and to sequentially output the first data voltage and the second data voltage as a pixel voltage to the pixel during the present frame.

The present invention also discloses a method for driving a display apparatus, including receiving an input image signal of a present frame and an input image signal of a next frame, compensating the input image signal of the present frame to output a first output image signal during a first period of the present frame, interpolating the input image signal of the present frame and the input image signal of the next frame to output a second output image signal during a second period of the present frame, the second period having a duration that is different than a duration of the first period, generating a first gray-scale voltage group corresponding to a first gamma curve and generating a second gray-scale voltage group corresponding to a second gamma curve, and converting the first output image signal to a first data voltage based on the first gray-scale voltage group and converting the second output image signal to a second data voltage based on the second gray-scale voltage group to sequentially output the first data voltage and the second data voltage to a pixel of the display apparatus.

The present invention also discloses signal controller of a display apparatus that receives an input image signal of a present frame and an input image signal of a next frame. The signal controller includes a frame memory to store the input image signal of the present frame, an image compensator to compensate the input image signal of the present frame and to output a first output image signal, an image interpolator to interpolate the input image signal of the present frame and the input image signal of the next frame, and to output a second output image signal, and a first selection circuit to alternately output the first output image signal during a first period of the present frame and the second output image signal during a second period of the present frame in response to a selection signal. Further, the first selection circuit outputs the first output image signal or the second output image signal to a data driver, the data driver to convert the first output image signal to a first data voltage and to transmit the first data voltage as a pixel voltage to a pixel during the first period, and to convert the second output image signal to a second data voltage and to transmit the second data voltage as a pixel voltage to the pixel during the second period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing an LCD according to an exemplary embodiment of the present invention.

FIG. 2 is an equivalent circuit diagram showing a pixel PX from Region A of FIG. 1.

FIG. 3 is a block diagram showing a signal controller of FIG. 1.

FIG. 4 is a waveform diagram showing a data voltage applied to a pixel of FIG. 1.

FIG. 5 is a block diagram showing a gray-scale voltage generator of FIG. 1.

FIG. 6 is a graph showing gamma curves corresponding to first and second gray-scale groups.

FIG. 7 is a flow chart illustrating a driving method of the LCD of FIG. 1.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on”, “connected to” or “coupled to” another element or layer, it can be directly on, connected or coupled to the other element or layer, or intervening elements or layers may be present. In contrast, if an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

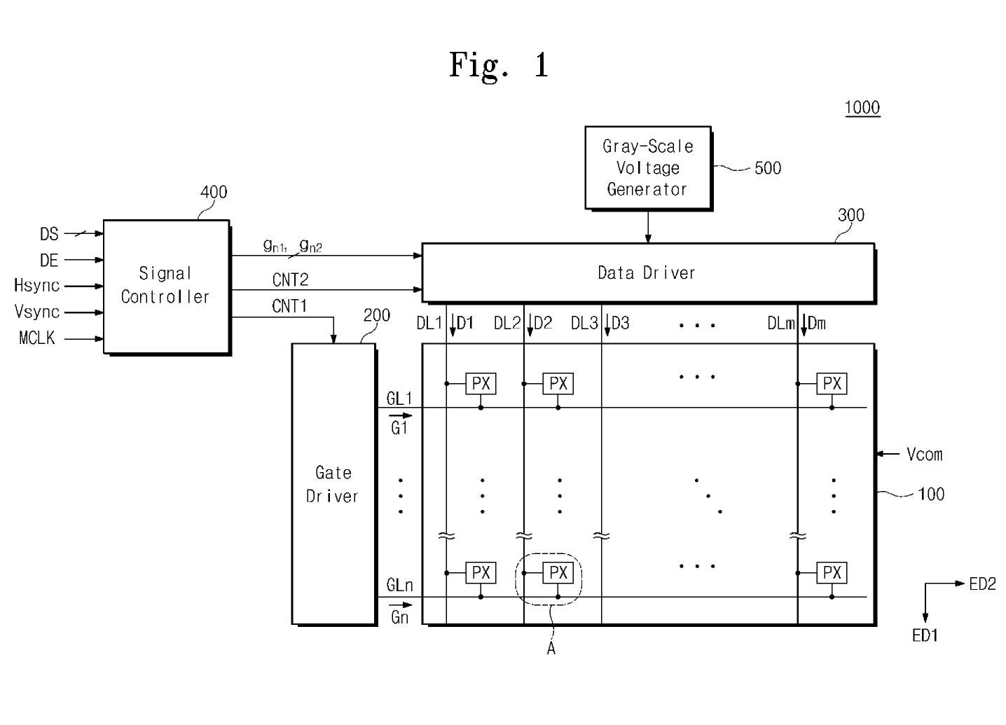

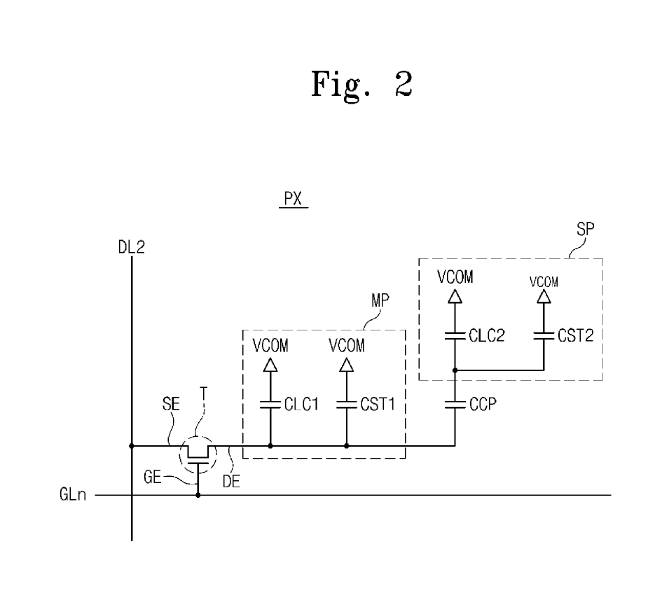

FIG. 1 is a block diagram showing an LCD according to an exemplary embodiment of the present invention, and FIG. 2 is an equivalent circuit diagram showing a pixel PX from Region A of FIG. 1.

Referring to FIG. 1, an LCD 1000 includes an LCD panel 100, a gate driver 200, a data driver 300, a gray-scale voltage generator 500 that generates gray-scale voltages and transmits the gray-scale voltages to the data driver 300, and a signal controller 400 that controls the gate driver 200 and the data driver 300.

The LCD panel 100 includes signal lines GL1, . . . , GLn and DL1, . . . , DLm and pixels PX arranged in a matrix configuration.

The signal lines GL1, . . . , GLn and DL1, . . . , DLm include gate lines GL1, GLn to transmit gate signals G1, . . . , Gn, which may be referred to as scan signals, and data lines DL1, . . . , DLm to transmit data signals D1, . . . , Dm. Each pixel PX is connected to one of the gate lines GL1, . . . , GLn and one of the data lines DL1, . . . , DLm.

The data lines DL1, . . . , DLm extend in a first direction ED1 and are substantially parallel to each other. The gate lines GL1, . . . , GLn extend in a second direction ED2 substantially perpendicular to the first direction ED1 and are substantially parallel to each other.

Referring to FIG. 2, which shows a pixel PX from Region A as a representative pixel PX of the LCD panel 100, each pixel PX includes a switching device T, a main pixel MP, a sub pixel SP, and a coupling capacitor CCP, and is operated in a coupling-capacitor (CC)-type Super-PVA (S-PVA) mode using the coupling capacitor CCP.

The switching device T may be a thin film transistor T. The thin film transistor T includes a gate electrode GE connected to the corresponding gate line GLn, a source electrode SE connected to the corresponding data line DL2, and a drain electrode DE connected to the main pixel MP.

The main pixel MP includes a first liquid crystal capacitor CLC1 and a first storage capacitor CST1. The first liquid crystal capacitor CLC1 includes a first terminal connected to the drain electrode DE of the thin film transistor T and a second terminal connected to the common electrode, to which the common voltage VCOM is applied. The first storage capacitor CST1 is connected to drain electrode DE and the common electrode in parallel with the first liquid crystal capacitor CLC1. Thus, the first storage capacitor CST1 includes a first terminal connected to the drain electrode DE of the thin film transistor T and the first terminal of the first liquid crystal capacitor CLC1, and a second terminal connected to the common electrode.

A first terminal of the coupling capacitor CCP is connected to the drain electrode DE of the thin film transistor T and the main pixel MP, and a second terminal of the coupling capacitor CCP is connected to the sub pixel SP.

The sub pixel SP includes a second liquid crystal capacitor CLC2 and a second storage capacitor CST2. The second liquid crystal capacitor CLC2 includes a first terminal connected to the second terminal of the coupling capacitor CCP and a second terminal connected to the common electrode. The second storage capacitor CST2 is connected to the second terminal of the coupling capacitor CCP and the common electrode in parallel with the second liquid crystal capacitor CLC2. Thus, the second storage capacitor CST2 includes a first terminal connected to the second terminal of the coupling capacitor CCP and the first terminal of the second liquid crystal capacitor CLC2, and a second terminal connected to the common electrode.

When a gate signal Gn is applied to the gate line GLn, the thin film transistor T is turned on so that the data signal D2 applied to the data line DL2 is transmitted to the drain electrode DE. The data signal D2 transmitted to the drain electrode DE is charged in the main pixel MP and the sub pixel SP. The voltage charged in the sub pixel SP is lower than the voltage charged in the main pixel MP because the coupling capacitor CCP is charged.

Because of the voltage difference between the voltage charged in the main pixel MP and the voltage charged in the sub pixel SP, liquid crystal molecules corresponding to the sub pixel SP are tilted slightly in comparison with those corresponding to the main pixel MP. Thus, when the light passing through the main pixel MP and the light passing through the sub pixel SP are added to each other, the front brightness and the side visibility may be improved.

The gate driver 200 sequentially applies a gate-on signal to the gate lines GL1, . . . , GLn as the gate signals G1, . . . , Gn in response to a gate control signal CNT1 to turn on the switching devices T connected to the gate lines GL1, . . . , GLn. The gate control signal CNT1 includes a scan start signal to indicate the start of the scan and at least one clock signal to control an output timing of the gate-on signal. Further, the gate control signal CNT1 may further include an output enable signal to control the duration of the gate-on signal.

Then, the data signals D1, . . . , Dm applied to the data lines DL1, . . . , DLm are applied to the pixels PX through the turned on switching devices T.

The data driver 300 is connected to the data lines DL1, . . . , DLm of the LCD panel 100 and receives the gray-scales from the gray-scale voltage generator 500 in response to a data control signal CNT2 and output image signals received from the signal controller 400.

The data driver 300 applies the gray-scales to the data lines DL1, . . . , DLm as the data signals D1, . . . , Dm. The output image signals received from the signal controller 400 include a first output image signal gₙ₁ and a second output image signal gₙ₂. The first output image signal gₙ₁ and the second output image signal gₙ₂ may be obtained by correcting and interpolating the input image signals DS applied to the signal controller 400. Specifically, the input image signals DS may have a first frame frequency, and the first output image signal gₙ₁ and the second output image signal gₙ₂ may have a second frame frequency that is greater than the first frame frequency. Specifically, the second frame frequency of the first output image signal gₙ₁ and the second output image signal gₙ₂ may be two times greater than the first frame frequency. The frame frequency will be described in detail below.

The data control signal CNT2 includes a horizontal synchronizing start signal STH to indicate the transmission of the image signals of the pixels PX arranged in one row, a load signal to indicate that the data signals D1, . . . , Dm are applied to the data lines DL1, . . . , DLm, and a data clock signal. The data control signal CNT2 may further include an inversion signal to invert the polarity of the data signals D1, . . . , Dm with respect to the common voltage VCOM.

The data driver 300 receives the data control signal CNT2, the first output image signal gₙ₁, and the second output image signal gₙ₂ from the signal controller 400.

The data driver 300 converts the first output image signal gₙ₁ from the signal controller 400 into a first data voltage based on a first gray-scale voltage group received from the gray-scale voltage generator 500, and converts the second output image signal gₙ₂ from the signal controller 400 into a second data voltage based on a second gray-scale voltage group received from the gray-scale voltage generator 500. Thus, the data driver 300 selects the first gray-scale, which corresponds to the first output image signal gₙ₁, from the gray-scales of the first gray-scale group and applies the selected first gray-scale to corresponding pixels PX as the first data voltage. Also, the data driver 300 selects the second gray-scale, which corresponds to the second output image signal gₙ₂, from the gray-scales of the second gray-scale group and applies the selected second gray-scale to the corresponding pixels PX as the second data voltage.

As described above, the data driver 300 selects the gray-scales corresponding to the first output image signal gₙ₁ and the second output image signal gₙ₂, and respectively converts the first output image signal gₙ₁ and the second output image signal gₙ₂ having digital data formats into the first data voltage and the second data voltage having analog data formats to apply the first data voltage and the second data voltage to corresponding data lines DL1, . . . , DLm.

The signal controller 400 outputs the first output image signal gₙ₁, the second output image signal gₙ₂, and data control signal CNT2 to the data driver 300, and outputs the gate control signal CNT1 to the gate driver 200 in response to the input image signals DA and input control signals provided from, for example, an external graphic controller (not shown).

The input control signals may include a vertical synchronizing signal Vsync, a horizontal synchronizing signal Hsync, a main clock signal MCLK, and a data enable signal DE.

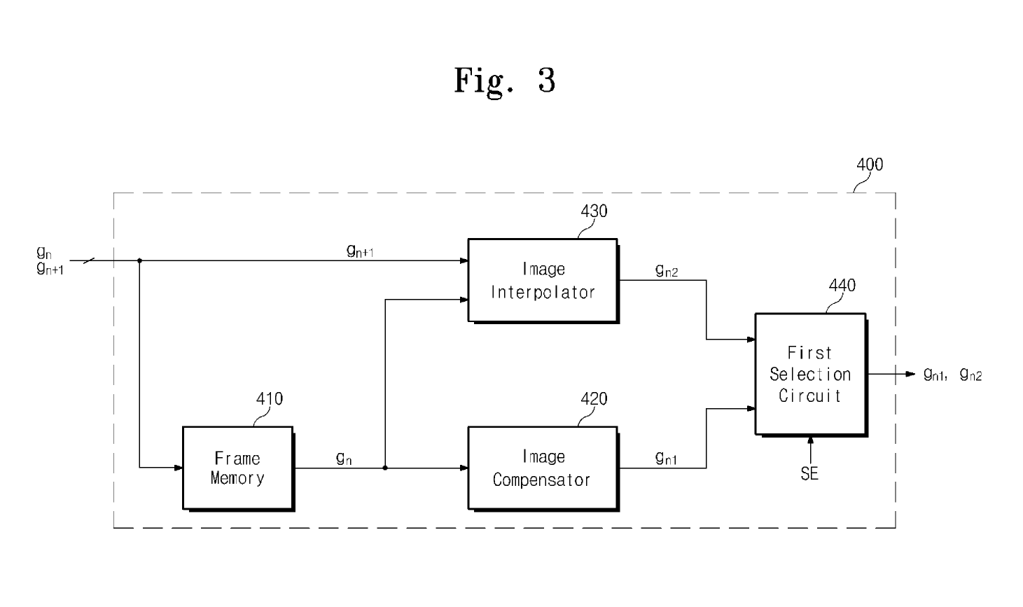

Hereinafter, the signal controller 400 will be described in detail with reference to FIG. 3.

FIG. 3 is a block diagram showing a signal controller of FIG. 1.

Referring to FIG. 3, the signal controller 400 includes a frame memory 410, an image compensator 420, an image interpolator 430, and a first selection circuit 440.

The frame memory 410 receives and stores the input image signals DS corresponding to a present frame. When the input image signals DS corresponding to a next frame are input, the frame memory 410 outputs the input image signals DS corresponding to the present frame stored therein. In the present exemplary embodiment, the input image signals DS corresponding to the present frame and the input image signals DS corresponding to the next frame are represented by gₙ and gₙ₊₁, respectively.

The image compensator 420 receives the input image signal gₙ corresponding to the present frame from the frame memory 410, and outputs the compensated input image signal gₙ as the first output image signal gₙ₁ during a first period of one frame.

The image interpolator 430 receives the input image signal gₙ corresponding to the present frame from the frame memory 410 and also receives the input image signal gₙ₊₁ corresponding to the next frame. If the input image signals gₙ and gₙ₊₁ between the present and next frames represent moving images to be displayed on the LCD panel 100, the image interpolator 430 performs a motion interpolation method to output the second output image signal gₙ₂. The image interpolator 430 outputs the second output image signal gₙ₂ during a second period having a duration that may be different than a duration of the first period. The duration of the second period may be longer or shorter than the duration of the first period.

The first output image signal gₙ₁ and the second output image signal gₙ₂ are applied to the first selection circuit 440.

The motion interpolation method generates a prediction image (or a prediction field) through a motion presumption and an interpolation between images (or fields) displayed in two adjacent frames and inserts the prediction image (e.g. the second image signal gₙ₂) between each frame. For the motion interpolation method, the image interpolator 430 may include a chip in which an algorithm for the motion interpolation method is programmed.

The LCD 1000 sequentially applies the second output image signal gₙ₂ interpolated by the motion interpolation method to corresponding pixels PX with the first output image signal gₙ₁, thereby improving blurring of the moving images, which may occur when displaying the moving images.

Also, the LCD 1000 controls a duration ratio of the first output image signal gₙ₁ and the second output image signal gₙ₂ within a frame to thereby better improve the blurring of the moving images. The duration ratio may be a ratio of the duration of the second period to the duration of the first period, or vice-versa.

Referring to FIG. 3, the first selection circuit 440 sequentially outputs the first output image signal gₙ₁ from the image compensator 420 and the second output image signal gₙ₂ from the image interpolator 430 in response to a selection signal SE. The first output image signal gₙ₁ and the second output image signal gₙ₂ output from the first selection circuit 440 are applied to the data driver 300. For instance, if the selection signal SE is at a low logic level (L), the first selection circuit 440 may output the first output image signal gₙ₁ to the data driver 300, and if the selection signal SE is at a high logic level (H), the first selection circuit 440 may output the second output image signal gₙ₂ to the data driver 300. Thus, according to the logic state of the selection signal SE, the first data voltage corresponding to the first output image signal gₙ₁ may be applied to the corresponding pixels PX from the data driver 300 prior to the second output image signal gₙ₂, or the second data voltage corresponding to the second output image signal gₙ₂ may be applied to the corresponding pixels PX from the data driver 300 prior to the first output image signal gₙ₁. Further, the selection signal SE may be applied from an exterior source (not shown).

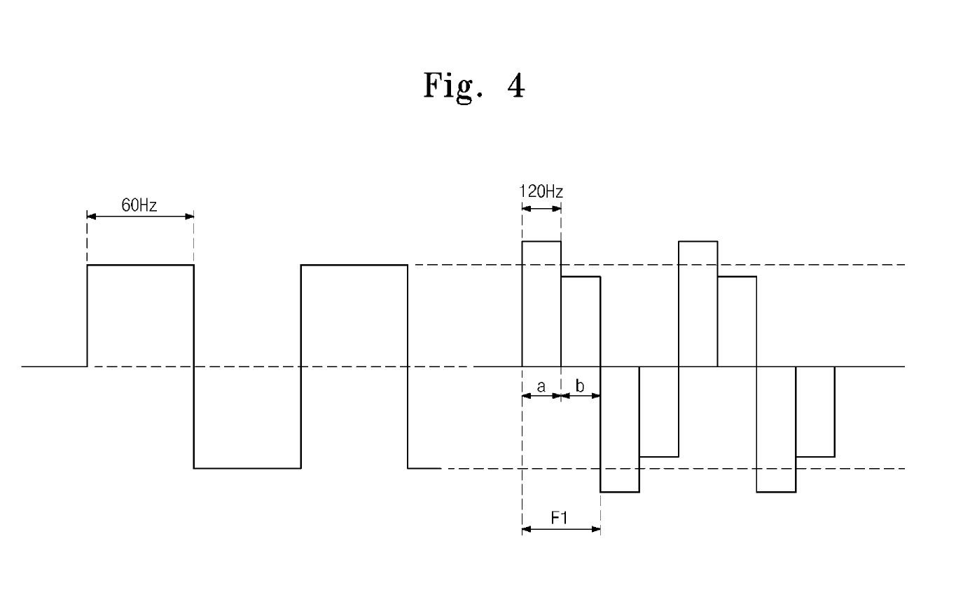

FIG. 4 is a waveform diagram showing a data voltage applied to a pixel of FIG. 1. More specifically, FIG. 4 is a waveform diagram showing the first output image signal gₙ₁ and the second output image signal gₙ₂ applied to the pixel PX shown in FIG. 2. In FIG. 4, the first two cycles shown on the left portion of the waveform represent the input image signal DS having the first frame frequency of 60 Hz, and the second two cycles shown on the right portion of the waveform represent the first output image signal gₙ₁ and the second output image signal gₙ₂ having the second frame frequency of 120 Hz.

As shown in the right portion of the waveform of FIG. 4, the first output image signal gₙ₁ is output during a first period (a) of a first frame F1 and the second output image signal gₙ₂ is output during a second period (b) of the first frame F1. Alternatively, the first output image signal gₙ₁ may be output during the second period (b) of the first frame F1, and the second output image signal gₙ₂ may be output during the first period (a) of the first frame F1. In FIG. 4, the first period (a) and the second period (b) are shown having the same duration, but the first period (a) and the second period (b) may have different durations. Specifically, as described above, the duration of the second period may be longer or shorter than the duration of the first period.

Referring again to FIG. 1, the gray-scale voltage generator 500 generates the first gray-scale voltage group and the second gray-scale voltage group related to the transmittance of the pixels PX.

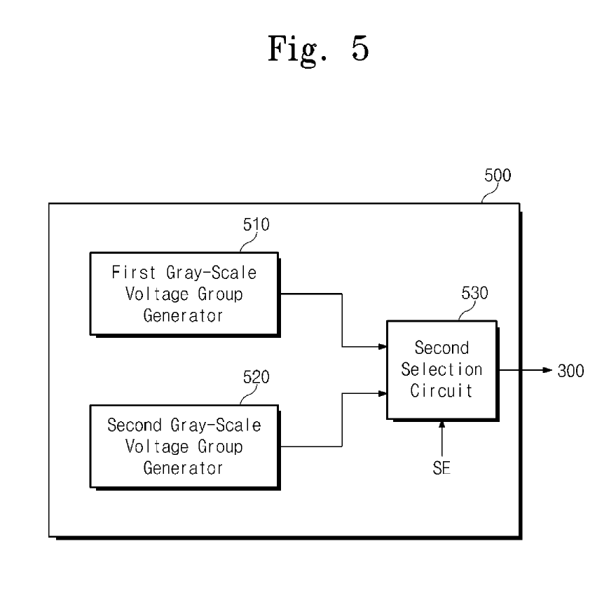

FIG. 5 is a block diagram showing a gray-scale voltage generator of FIG. 1.

Referring to FIG. 5, the gray-scale voltage generator 500 includes a first gray-scale voltage group generator 510, a second gray-scale voltage group generator 520, and a second selection circuit 530.

The first gray-scale voltage group generator 510 and the second gray-scale voltage group generator 520 each include a resistor string to generate the first gray-scale voltage group and the second gray-scale voltage group, respectively. The first gray-scale voltage group generator 510 generates the first gray-scale voltage group corresponding to the first output image signal gₙ₁, and the second gray-scale voltage group generator 520 generates the second gray-scale voltage group corresponding to the second output image signal gₙ₂.

The second selection circuit 530 provides the first gray-scale voltage group or the second gray-scale voltage group to the data driver 300 according to the logic state of the selection signal SE applied to the first selection circuit 440. For example, the second selection circuit 530 may provide the first gray-scale voltage group to the data driver 300 in response to the selection signal SE having the low logic level (L) during the first period (a) when the first output image signal gₙ₁ is output, and may provide the second gray-scale voltage group to the data driver 300 in response to the selection signal SE having the high logic level (H) during the second period (b) when the second output image signal gₙ₂ is output. Referring to FIG. 5, the second selection circuit 530 has been described as arranged inside the gray-scale voltage generator 500, but the second selection circuit 530 may be arranged outside the gray-scale voltage generator 500, such as inside the data driver 300.

The first gray-scale voltage group generator 510 generates the first gray-scale voltage group V0, V1, V2, . . . , Vm based on a first gamma curve g1, and the second gray-scale voltage group generator 520 generates the second gray-scale voltage group V0′, V1′, V2′, . . . , Vm′ based on a second gamma curve g2. Particularly, the first gray-scale voltage group and the second gray-scale voltage group are generated based on the first gamma curve g1 and the second gamma curve g2 having different gamma values corresponding to the gray-scales.

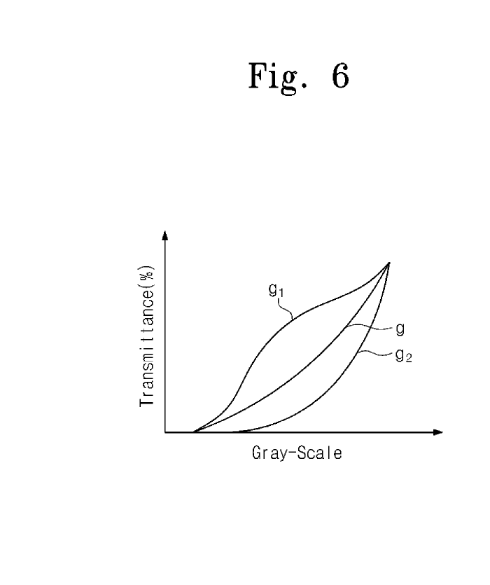

FIG. 6 is a graph showing gamma curves corresponding to first gray-scale voltage group and second gray-scale voltage group. In FIG. 6, a reference gamma curve g, a first gamma curve g1 having a first gamma value, and a second gamma curve g2 having a second gamma value are shown. The reference gamma curve g indicates a gamma curve applied to a conventional display apparatus and may have a gamma value of 2.4. The first gamma curve g1 and the second gamma curve g2 may be impulsive gamma curves having gamma values other than 2.4, and the second gamma curve g2 may have a lower brightness than the first gamma curve g1 for a corresponding gray-scale.

Thus, a average of transmittances of the first gamma curve g1 and the second gamma curve g2 corresponding to a certain gray-scale level may be equal to the transmittance of the reference gamma curve g corresponding to the same certain gray-scale level.

The various driving devices, such as the gate driver 200, the data driver 300, the signal controller 400, and the gray-scale voltage generator 500, may be arranged in the form of a chip and directly mounted on the LCD panel 100. Alternatively, the various driving devices may be mounted on a flexible printed circuit board connected to the LCD panel 100.

Hereinafter, an operation of the LCD 1000 will be described in detail.

The input image signal DS of the present frame and the input image signal DS of the next frame are sequentially input to the signal controller 400. The input image signal DS of the present frame and the input image signal DS of the next frame each have the first frame frequency, such as 60 Hz. The image compensator 420 of the signal controller 400 compensates the input image signal DS of the present frame to have the second frame frequency, such as 120 Hz, and outputs the first output image signal gₙ₁. The image interpolator 430 of the signal controller 400 outputs the second output image signal gₙ₂ having the second frame frequency using the input image signal DS of the present frame and the input image signal DS of the next frame.

The selection signal SE is applied to the first selection circuit 440 of the signal controller 400. Then, the first output image signal gₙ₁ or the second output image signal gₙ₂ is applied to the data driver 300 according to the logic state of the selection signal SE.

The selection signal SE is also applied to the second selection circuit 530 of the gray-scale voltage generator 500. The second selection circuit 530 outputs the first gray-scale voltage group V0, V1, V2, . . . , Vm corresponding to the first output image signal gₙ₁ or the second gray-scale voltage group V0′, V1′, V2′, . . . , Vm′ corresponding to the second output image signal gₙ₂ to the data driver 300 according to the logic state of the selection signal SE.

The data driver 300 converts the first output image signal gₙ₁ to the first data voltage using the first gray-scale voltage group and converts the second output image signal gₙ₂ to the second data voltage using the second gray-scale voltage group. The first data voltage and the second data voltage are sequentially applied to the corresponding pixels PX as the data signals D1, . . . , Dm.

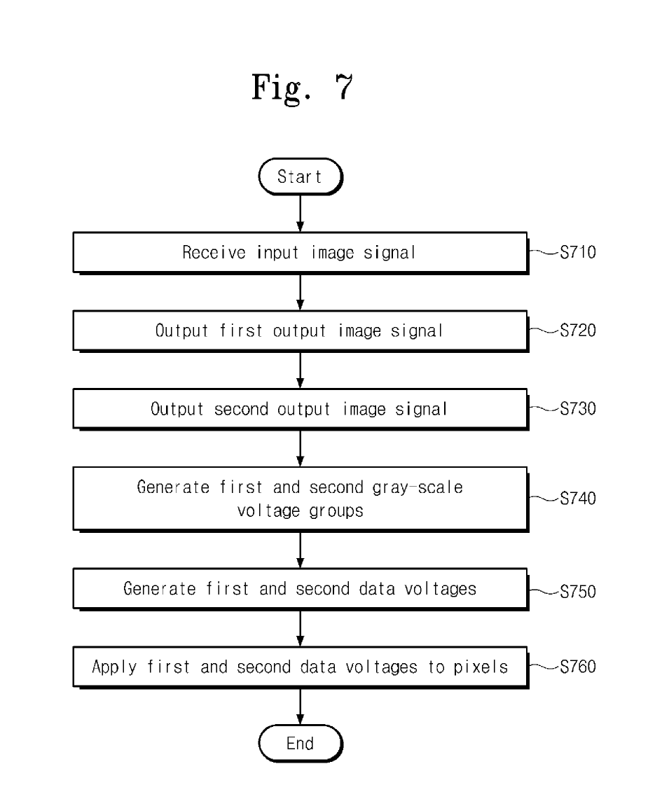

Hereinafter, a method for driving the LCD will be described in detail with reference to FIG. 7.

FIG. 7 is a flow chart illustrating a driving method of the LCD of FIG. 1.

Referring to FIG. 7, the signal controller 400 sequentially receives the input image signals DS of the present frame and the input image signals DS of the next frame (S710).

The image compensator 420 of the signal controller 400 compensates the input image signals DS of the present frame to output the first output image signal gₙ₁ to the data driver 300 during the first period (a) of a frame (S720). The image interpolator 430 of the signal controller 400 interpolates the input image signals DS of the present frame and the input image signals DS of the next frame to output the second output image signal gₙ₂ to the data driver 300 during the second period (b) of the frame (S730).

The gray-scale voltage generator 500 generates the first gray-scale voltage group and the second gray-scale voltage group respectively corresponding to the first output image signal gₙ₁ and the second output image signal gₙ₂ output from the signal controller 400. The gray-scale voltage generator 500 provides the first gray-scale voltage group or the second gray-scale voltage group to the data driver 300 according to the first output image signal gₙ₁ and the second output image signal gₙ₂ input to the data driver 300 (S740).

The data driver 300 generates the first data voltage by converting the first output image signal gₙ₁ to the first data voltage based on the first gray-scale voltage group, and generates the second data voltage by converting the second output image signal gₙ₂ to the second data voltage based on the second gray-scale voltage group (S750). The first data voltage and the second data voltage are sequentially applied to the corresponding pixels PX as the data signals D1, . . . , Dm (S760).

According to the LCD and the method for driving the LCD, input image signals having the first frame frequency are converted to the first output image signal and the second output image signal having the second frame frequency. The gray-scale of the image corresponding to the first output image signal depends on the first gamma curve, and the gray-scale of the image corresponding to the second output image signal depends on the second gamma curve having a lower brightness than that of the first gamma curve. Thus, the blurring of the moving images by an impulsive operation may be prevented.

Also, since the second output image signal is generated through the motion interpolation method, the blurring may be more effectively prevented.

Further, the driving circuit for the LCD may be simplified since the pixels PX may have the CC-type S-PVA structure, which includes only one switching device per pixel PX.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a pixel;
a signal controller to receive an input image signal of a present frame and an input image signal of a next frame, to compensate the input image signal of the present frame to output a first output image signal during a first period of the present frame, and to interpolate the input image signal of the present frame and the input image signal of the next frame to output a second output image signal during a second period of the present frame, the second period having a duration that is different than a duration of the first period;
a gray-scale voltage generator to generate a first gray-scale voltage group corresponding to a first gamma curve and a second gray-scale voltage group corresponding to a second gamma curve; and
a data driver to convert the first output image signal to a first data voltage based on the first gray-scale voltage group, to convert the second output image signal to a second data voltage based on the second gray-scale voltage group, and to sequentially output the first data voltage and the second data voltage as a pixel voltage to the pixel during the present frame.

2. The display apparatus of claim 1, wherein the pixel comprises a main pixel to receive a selected data voltage of the first data voltage and the second data voltage, and a sub pixel to receive a remaining data voltage of the first data voltage and the second data voltage, and the remaining data voltage has a voltage level lower than the selected data voltage.

3. The display apparatus of claim 2, further comprising a gate driver to generate a gate pulse, and
wherein the pixel further comprises:
a thin film transistor to output the selected data voltage in response to the gate pulse;
a first liquid crystal capacitor connected to the thin film transistor and charged with the selected data voltage;
a coupling capacitor connected in parallel with the first liquid crystal capacitor to receive the selected data voltage; and
a second liquid crystal capacitor connected to the coupling capacitor and charged with the remaining data voltage.

4. The display apparatus of claim 1, wherein a first gamma value corresponding to the first gamma curve is different than a second gamma value corresponding to the second gamma curve.

5. The display apparatus of claim 4, wherein a average of transmittances of the first gamma curve and the second gamma curve corresponds to a transmittance of a reference gamma curve between the first gamma curve and the second gamma curve, and the reference gamma curve has a gamma value of 2.4.

6. The display apparatus of claim 4, wherein a brightness corresponding to a gray-scale based on the first gamma curve is greater than a brightness corresponding to the gray-scale based on the second gamma curve.

7. The display apparatus of claim 1, wherein the duration of the first period is longer than the duration of the second period.

8. The display apparatus of claim 1, wherein the duration of the first period is shorter than the duration of the second period.

9. The display apparatus of claim 7, wherein the first output image signal and the second output image signal each have a frame frequency of about 120 Hz.

10. The display apparatus of claim 1, wherein the signal controller comprises:
a frame memory to store the input image signal of the present frame and to output the stored input image signal of the present frame;
an image compensator to compensate the input image signal of the present frame and to output the first output image signal;
an image interpolator to interpolate the input image signal of the present frame and the input image signal of the next frame, and to output the second output image signal; and
a first selection circuit to alternately output the first output image signal and the second output image signal to the data driver in response to a selection signal.

11. The display apparatus of claim 10, wherein the gray-scale voltage generator comprises:
a first gray-scale voltage group generator to generate the first gray-scale voltage group;
a second gray-scale voltage group generator to generate the second gray-scale voltage group; and
a second selection circuit to alternately output the first gray-scale voltage group and the second gray-scale voltage group in response to the selection signal.

12. A method for driving a display apparatus, the method comprising:
receiving an input image signal of a present frame and an input image signal of a next frame;
compensating the input image signal of the present frame to output a first output image signal during a first period of the present frame;
interpolating the input image signal of the present frame and the input image signal of the next frame to output a second output image signal during a second period of the present frame, the second period having a duration that is different than a duration of the first period;
generating a first gray-scale voltage group corresponding to a first gamma curve and generating a second gray-scale voltage group corresponding to a second gamma curve; and
converting the first output image signal to a first data voltage based on the first gray-scale voltage group and converting the second output image signal to a second data voltage based on the second gray-scale voltage group to sequentially output the first data voltage and the second data voltage to a pixel of the display apparatus.

13. The method of claim 12, wherein a first gamma value corresponding to the first gamma curve is different than a second gamma value corresponding to the second gamma curve.

14. The method of claim 13, wherein a average of transmittances of the first gamma curve and the second gamma curve correspond to a transmittance of a reference gamma curve between the first gamma curve and the second gamma curve, and the reference gamma curve has a gamma value of 2.4.

15. The method of claim 12, wherein the duration of the first period is longer than the duration of the second period.

16. The method of claim 12, wherein the duration of the first period is shorter than the duration of the second period.

17. The method of claim 12, wherein the first output image signal and the second output image signal each have a frame frequency of about 120 Hz.

18. A signal controller of a display apparatus that receives an input image signal of a present frame and an input image signal of a next frame, the signal controller comprising:
a frame memory to store the input image signal of the present frame;
an image compensator to compensate the input image signal of the present frame and to output a first output image signal;
an image interpolator to interpolate the input image signal of the present frame and the input image signal of the next frame, and to output a second output image signal; and
a first selection circuit to alternately output the first output image signal during a first period of the present frame and the second output image signal during a second period of the present frame in response to a selection signal,
wherein the first selection circuit outputs the first output image signal or the second output image signal to a data driver, the data driver to convert the first output image signal to a first data voltage and to transmit the first data voltage as a pixel voltage to a pixel during the first period, and to convert the second output image signal to a second data voltage and to transmit the second data voltage as a pixel voltage to the pixel during the second period.

19. The signal controller of claim 18, wherein a frequency of the present frame is 60 Hz, a frequency of the first period is 120 Hz, and a frequency of the second period is 120 Hz.

20. The signal controller of claim 18, wherein the first data voltage and the second data voltage are respectively converted based on a first gray-scale voltage group and a second gray-scale voltage group generated by a gray-scale voltage generator and output in response to the selection signal.
